(19) United States
(12) Patent Application Publication
(10) Pub. No.: US 2005/0173970 A1
(43) Pub. Date: Aug. 11, 2005

(54) Wheel rim structure

(75) Inventor: Ming-Liang Lin, Tainan Hsien (TW)

Correspondence Address: BACON & THOMAS, PLLC, 625 SLATERS LANE, FOURTH FLOOR, ALEXANDRIA, VA, 22314, US

(73) Assignee: King Hwa Sin Industrial, Tainan Hsien (TW)

(21) Appl. No.: 10/774,431

(22) Filed: Feb. 10, 2004

(51) Int. Cl. B60B 3/10

(52) U.S. Cl. 301/64.305

(57) ABSTRACT

A wheel rim structure comprised of a first wheel member having a disk with a plurality of primary mounting holes and a rim portion; a second wheel member having a disk with a plurality of primary mounting holes and a rim portion; and a side plate having a disk with a plurality of primary mounting holes. The first wheel member disk is placed against the second wheel member disk and the side plate disk is placed against the first wheel member disk. The side plate, the first wheel member, and the second wheel member are then conjoined into a one-piece entity and, furthermore, mounted on a vehicle hub with threaded fastening components through the primary mounting holes.

### BACKGROUND OF THE INVENTION

1) Field of the Invention

The invention herein relates to automotive parts and accessories, specifically a wheel rim structure that is structurally simplified and capable of reducing die retooling, while enabling a higher strength wheel rim.

2) Description of the Related Art

Conventional vehicle wheel rims often have a disk mounted to the wheel hub for the transfer of rotational force and rim portions for tire mounting formed from the circumference of the said disk. Some vehicles, such as compact cars, have annular unitarily formed rim portions with the disk mounted on the wheel hub at the inner diameter by welding. Some vehicles utilize two dish-shaped bodies, each having a disk and a rim portion formed from the disk circumferences, the two disks placed back-to-back against each other and held together with a plurality of threaded fastening components, thereby enabling the installation of a tire and mounting onto a vehicle hub. In the case of all-terrain vehicles that sustain large torque resistance and lateral pressure wheel deflection when operated on sandy beaches, the massive destructive forces encountered has resulted in disk reinforcing designs such as U.S. Pat. No. 6,340,210 (Wheel for Vehicle) that utilizes a center plate sandwiched between the disks of the inner wheel halves and the outer wheel halves which are then held together by a plurality of threaded fastening components, enabling the outer diameters of the two inner and outer wheel half disks to each be larger than that of the said center plate such that the two disks at the center plate outer circumferential edge can be welded and conjoined into a single piece, with the center plate ensconced in the interior section.

The U.S. Pat. No. 6,340,210 provides an exceptionally strong disk that is mountable on vehicle hubs, but the said design involves the planar placement of the disks and the medial accommodation of the center plate which creates a rather wide interval. Additionally, in U.S. Pat. No. 6,340,210, the circumferential edges of the disk must be arcuately biased towards one side to provide for welding the confluent circumferential edges of the disks. As such, standard whole wheel rim dies must be replaced with pairs of split dish-shaped dies, which substantially increases production costs due to the considerably large size of the said dies.

### SUMMARY OF THE INVENTION

The objective of the invention herein is to provide a wheel rim structure comprised of:

A first wheel member having a disk and a rim portion that extends annularly towards one side from the circumferential edge of the said disk, with a plurality of primary mounting holes disposed in the disk.

A second wheel member having a disk and a rim portion that extends annularly towards one side from the circumferential edge of the said disk, with a plurality of primary mounting holes disposed in the disk.

A side plate consisting of a disk, with a plurality of primary mounting holes disposed in the disk.

Given the said structure, the first wheel member disk is placed against the second wheel member disk and the said side plate disk is placed against the first wheel member disk; the side plate, the first wheel member, and the second wheel member are conjoined into a one-piece entity and, furthermore, mounted on a vehicle hub with threaded fastening components through the primary mounting holes.

### BRIEF DESCRIPTION OF THE DRAWINGS

Other features and advantages of the present invention will become apparent in the following detailed description of the preferred embodiment, with reference to the accompanying drawings in which:

FIG. 1 is an orthographic drawing of FIG. 2, as viewed from above.

FIG. 2 is a cross-sectional drawing of the preferred embodiment welded first and second wheel of the invention herein.

FIG. 3 is an orthographic drawing of FIG. 4, as viewed from above.

FIG. 4 is a cross-sectional drawing of the preferred embodiment “side plate” of the invention herein.

FIG. 5 is an orthographic drawing of FIG. 6, as viewed from above.

FIG. 6 is a cross-sectional drawing of the preferred embodiment hub conjoinment of the invention herein.

### DETAILED DESCRIPTION OF THE PREFERRED EMBODIMENTS

In the detailed description of the preferred embodiments, it should be noted that similar elements are indicated by the same reference numerals throughout the disclosure.

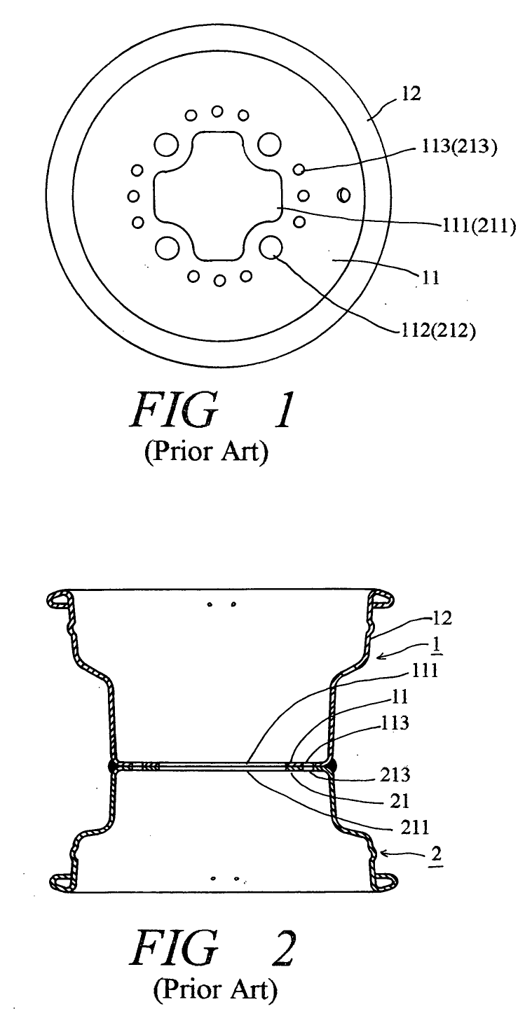

Referring to FIG. 1 and FIG. 2, the preferred embodiment wheel rim of the invention herein are comprised of:

A first wheel member 1, nominally dish-shaped, having a generally planar disk 11 and a rim portion 12 that extends annularly towards one side from the circumferential edge of the said disk 11; a reticulation 111 of an appropriate shape is formed in the center of the disk 11 and, furthermore, a plurality of larger diameter primary mounting holes 112 as well as a plurality of three-in-a-group smaller diameter secondary mounting holes 113 are disposed around the reticulation 111.

A second wheel member 2, nominally dish-shaped, having a generally planar disk 21 and a rim portion 22 that extends annularly towards one side from the circumferential edge of the said disk 21; a reticulation 211 of an appropriate shape is formed in the center of the disk 21 and, furthermore, a plurality of larger diameter primary mounting holes 212 as well as a plurality of three-in-a-group smaller diameter secondary mounting holes 213 are disposed around the reticulation 211.

The first wheel member 12 disk 11 is placed against the second wheel member 2 and disk 21, and then conjoined by welding into a one-piece entity along the confluent circumferential edges of said disks, indicated in FIG. 2 (other methods of conjoinment into a one-piece entity are also possible and shown in FIG. 5 and FIG. 6); at which time, the first wheel member 12 reticulation 111, the primary mounting holes 112, and the secondary mounting holes 113 are respectively aligned with the second wheel member 2 reticulation 211, the primary mounting holes 212, and the secondary mounting holes 213.

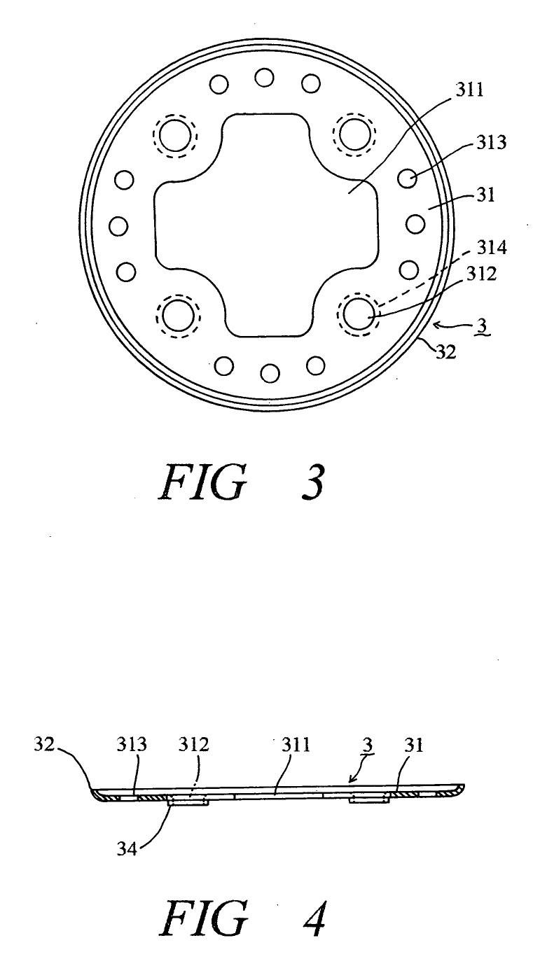

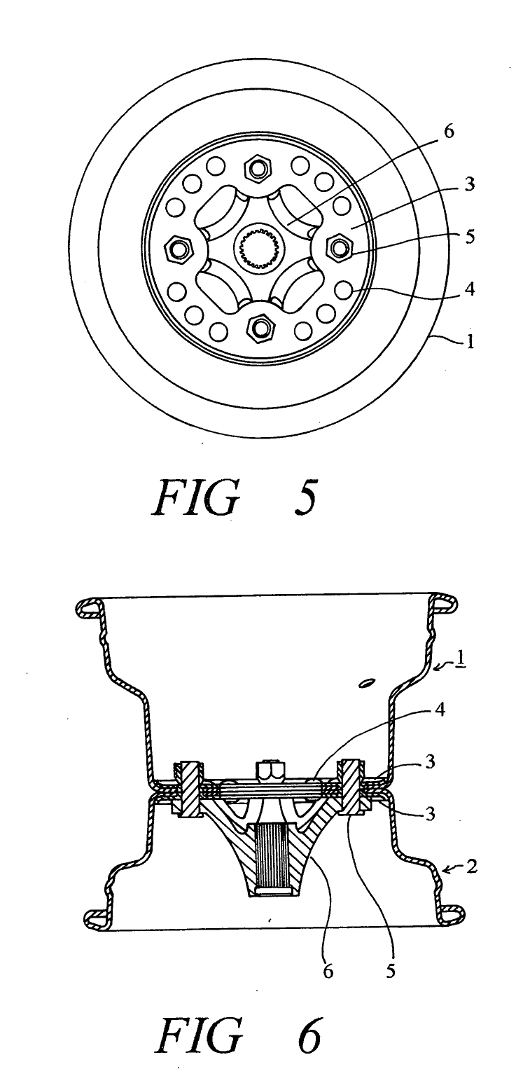

Referring to FIG. 3 and FIG. 4, the preferred embodiment of the invention herein is additionally comprised of two structurally identical side plates 3, each side plate 3 consisting of a generally planar disk 31 and an arcuate reinforcing rim portion 32 that extends towards one side from the said disk 31; a reticulation 311 of an appropriate shape is formed in the center of the disk 31 and, furthermore, a plurality of larger diameter primary mounting holes 312 as well as a plurality of three-in-a-group smaller diameter secondary mounting holes 313 are disposed around the reticulation 311, wherein each primary mounting hole 312 has an annular shoulder 314 projecting toward the side opposite from the rim portion 32.

Referring to FIG. 5 and FIG. 6, and also referencing the previous drawings, when the preferred embodiments of the invention herein are assembled, the first wheel member 1 and the second wheel member 2 are placed against each other at the disk 11 and the disk 21, at which time, the first wheel member 12 reticulation 111, primary mounting holes 112, and secondary mounting holes 113 are respectively aligned with the second wheel member 2 reticulation 211, primary mounting holes 212, and secondary mounting holes 213; the disk 31 of one side plate 3 is placed against the second wheel member 2 disk 21 such that the annular shoulders 314 are inserted into the primary mounting holes 212; the disk 31 of another side plate 3 is placed against the first wheel member 1 disk 11 such that the annular shoulders 314 are inserted into the primary mounting holes 212, following which rivet-type attachment components 4 are passed through the side plate 3 secondary mounting holes 313, the first wheel member 12 secondary mounting holes 113, the second wheel member 2 secondary mounting holes 113, and another side plate 3 secondary mounting holes 313, the four are then riveted into a one-piece structural entity (or, as shown in FIG. 2, the first wheel member 1 and the second wheel member 2 are placed against each other at the disk 11 and the disk 21, welded together along the confluent circumferential edges of the said disks, and then two side plates 3 are welded for conjoinment into a one-piece entity); bolt and nut threaded fastening components 5 are installed through a hub 6 and two side plates 3, the annular shoulders 314 of which are respectively inserted into the primary mounting holes 112 and 212 of the first wheel member 1 and the second wheel member 2, thereby enabling the mounting of the entire wheel rim onto the vehicle hub 6.

The preferred embodiments of the invention herein feature a design capable of strength reinforcement on the wheel rim, but since the disks 11 and 21 of the two wheel members 1 and 2 remain flush, whether the circumferential edges of the two wheel member 1 and 2 disks 11 and 21 are conjoined by welding or rivet-type attachment components 4, the circumferential edge shape at the two wheel member 1 and 2 disks 11 and 21 does not change and die modification is not is not required, thereby reducing production costs; additionally, the side plate 3 is not wedged into an interior space by the two disks 11 and 21, thereby facilitating assembly tasks; in terms of procedure, installing only one side plate 3 against the first wheel member 1 disk 11 or the second wheel member 2 disk 21 for conjoinment achieves the objective of the invention herein, but installing two side plates 3 on the disks 11 and 21 of the two wheel members 1 and 2, respectively, further optimizes the design.

While the present invention has been described in relation to what is considered the most practical and preferred embodiments, it is understood that the invention herein is not limited to the disclosed embodiments, but is intended to cover various arrangements included within the spirit and scope of the broadest interpretations and equivalent arrangements.

1. A wheel rim structure comprised of:
A first wheel member having a disk and a rim portion that extends annularly towards one side from the circumferential edge of the said disk, with a plurality of primary mounting holes disposed in the said disk.
A second wheel member having a disk and a rim portion that extends annularly towards one side from the circumferential edge of the said disk, with a plurality of primary mounting holes disposed in the said disk.
A side plate consisting of a disk, with a plurality of primary mounting holes disposed in the said disk.
Given the said structure, the said first wheel member disk is placed against the said second wheel member disk and the said side plate disk is placed against the said first wheel member disk; the said side plate, the said first wheel member, and the said second wheel member are conjoined into a one-piece entity and, furthermore, mounted on a vehicle hub with threaded fastening components through the said primary mounting holes.

2. As mentioned in claim 1 of the wheel rim structure invention herein, another said side plate disk is placed against the said second wheel member disk.

3. As mentioned in claim 1 of the wheel rim structure invention herein, the said side plate, the said first wheel member, and the said second wheel member are conjoined into a one-piece entity with attachment components.

4. As mentioned in claim 1 of the wheel rim structure invention herein, the said side plate, the said first wheel member, and the said second wheel member are conjoined into a one-piece entity by welding.

5. As mentioned in claim 1 of the wheel rim structure invention herein, the said side plate includes an arcuate rim portion that extends towards one side from the said disk.

6. As mentioned in claim 1 of the wheel rim structure invention herein, each said side plate primary mounting hole has an annular shoulder projecting towards one side.
